(19) United States
(12) Patent Application Publication
(10) Pub. No.: US 2013/0100042 A1
(43) Pub. Date: Apr. 25, 2013

(54) Touch screen implemented control panel

(71) Applicant: Robert H. Kincaid, Loveland, CO (US)

(72) Inventor: Robert H. Kincaid, Loveland, CO (US)

(21) Appl. No.: 13/279,175

(22) Filed: Oct. 21, 2011

(51) Int. Cl. G06F 3/041

(52) U.S. Cl. 345/173

(57) ABSTRACT

A control panel and method for using the same for controlling a device attached thereto is disclosed. The control panel includes a touch screen and a widget implemented on the touch screen. The widget controls a parameter in a device that is controlled by the control panel. The widget responds to first and second gestures. The first gesture sets a value for the parameter, and the second gesture alters a function that determines a relationship between the first gesture and the value. The touch screen may include an overlay that restricts the position of the widget and/or provides tactile feedback to a user while the user executes the first gesture.

### BACKGROUND OF THE INVENTION

Many devices include a control panel having a plurality of controls that set the manner in which the device operates. Traditionally, the controls were implemented using switches and potentiometers to provide inputs to the controller that supervises the device functions. These physical input devices were typically mounted on a panel and connected by wires to the controller. Such control panels were customized devices that were only used on one or, at most, a few devices. In essence, each device required a custom control panel. The need for such custom panels increased the cost of the device and the time needed to develop and market a new device.

With the advent of touch screen displays, the problem of providing a control panel has been greatly reduced, since a single touch screen can be programmed to provide a custom control panel for the associated device. In addition, the control functions of many devices are implemented by computers, and hence, the control panel and computer can be provided by programming the computer to provide a display that emulates the “controls” of the traditional control panel and detects the user's interaction with the touch screen to provide the desired changes in the device functions.

For example, a dial that sets the volume of a sound system can be implemented by displaying a picture of a dial on the touch screen. The user touches the dial with a finger and moves the finger to simulate moving the dial. The computer then alters the corresponding control parameter by an amount determined by the degree of movement input by the user. In addition, the computer changes the position of the dial in the display to reflect the new value of the control parameter.

Since the display and input regions of the screen are determined by the software, the same touch screen and control computer can be used to control a large range of instruments or other devices.

While such emulated control panels are a significant improvement over conventional panels constructed from dials and the like, there are still significant limitations, particularly when implementing controls that require fine adjustments or panels that require a large number of distinct controls. The resolution of a touch screen is limited by the size of the user's finger and the physical resolution of the screen touch sensor. To provide fine resolution, the dial must move a distance that is large compared to the smallest distance that the computer can detect with respect to movement of the finger on the screen. Furthermore, the contact area on the screen depends on the pressure with which the user presses the user's finger on the screen. Hence, to simulate a dial that can be positioned with a high degree of accuracy, the size of the emulated dial must be large compared to the size of the user's finger. Accordingly, large screens are preferred for such sensitive applications. Unfortunately, there are limitations to the size of the screens that can be used. The cost of the screens increases rapidly with size. In addition, the device being controlled can constrain the size of the screen. Hence, for many applications, there is a limit to the number of high resolution controls that can be implemented at any one time on the touch screen.

In addition, such emulated controls do not provide tactile feedback to the user as the user adjusts the dial. This limitation is particularly important in situations in which the user wishes to adjust a dial or other input component while viewing a graph or other visual output that is located such that the user cannot see both the dial and visual output simultaneously.

### SUMMARY OF PREFERRED EMBODIMENTS OF THE INVENTION

The present invention includes a control panel and method for using the same for controlling a device attached thereto. The control panel includes a touch screen and a widget implemented on the touch screen. The widget controls a parameter in a device that is controlled by the control panel. The widget responds to first and second gestures. The first gesture sets a value for the parameter, and the second gesture alters a function that determines a relationship between the first gesture and the value. The touch screen may include an overlay that restricts the position of the widget and/or provides tactile feedback to a user while the user executes the first gesture.

### BRIEF DESCRIPTION OF THE DRAWINGS

FIGS. 1A and 1B illustrate two examples of widgets.

FIGS. 2A-2B illustrate one embodiment of a tactile feedback overlay according to the present invention.

FIG. 3 illustrates another embodiment of a tactile feedback overlay that also includes an object that provides a more defined contact area with the touch screen.

FIG. 4 illustrates a slider widget according to another embodiment of the present invention.

FIG. 5 illustrates a control panel according to another embodiment of the present invention.

FIG. 6 illustrates the control panel shown in FIG. 5 after the user has moved the widget to the location that corresponds to adjusting the voltage V2.

FIGS. 7 and 8 illustrate the use of a widget that includes a knob such as that discussed above with reference to FIG. 3 that moves in a track between various positions corresponding to different parameters that can be adjusted.

FIG. 9 illustrates another embodiment of a control panel according to the present invention.

FIG. 10 illustrates another embodiment of the control panel according to the present invention.

### DETAILED DESCRIPTION OF PREFERRED EMBODIMENTS

For the purposes of this discussion, a touch screen is defined to be a display screen having a sensor that generates signals as to the locations at which a user touches the surface of the display with the user's fingers or styli. These signals can return properties such as location, orientation, size and/or shape of the touch event. Touch screens based on the electrical interaction of the screen with the user's fingers or styli as well as screens which sense the position of finger or stylus optically are known to the art, and hence, will not be discussed in detail here. It is sufficient to note that screens that measure the capacitance of the screen are utilized in many applications, the capacitance being altered by the user touching the screen. If a stylus or other object is held by the person touching the screen, the stylus or object must, typically, be designed such that user's capacitance is connected to the screen. Typically, a conducting object is grasped by the user and placed in contact with the screen.

Also, screens that measure the resistivity of the screen when the user touches the screen are known. Similarly, touch screens that sense the location of the point of contact optically are also known to the art.

A widget is defined to be a virtual control object that is implemented on a touch screen. The control object sets the value of one or more parameters in a system in which the control objects are defined. The control object has an element that is actuated by a user when the user interacts with the touch screen by touching the screen at a location associated with the object and/or moving the point of interaction with the screen. The act of touching the screen and then moving the user's fingers or styli on the screen while maintaining contact with the screen will be referred to as a gesture in the following discussion. The control object is characterized by a reference position and possibly other attributes such as size, shape, and/or orientation for the element.

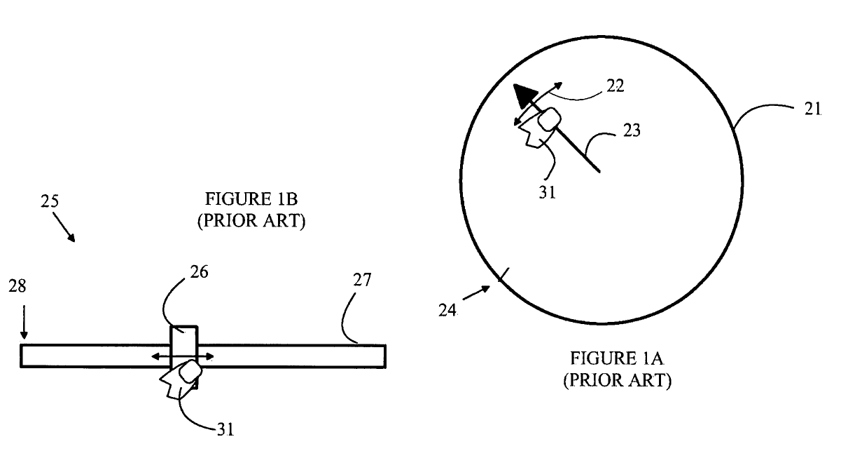

In one class of widgets, the value of a parameter set by the control object is determined by the distance between the current position of a moveable element in the widget and a reference position. Refer now to FIGS. 1A and 1B, which illustrate two examples of widgets. The widget shown in FIG. 1A is a “dial” widget 21. When the user's 31 touches the pointer on the dial and moves his or her finger in a direction indicated by arrow 22, the dial 23 in the display moves accordingly. In another embodiment, the user merely touches the screen inside the dial area. The location of the touch is determined and the dial is moved such that the dial passes through the center of the touched area. A parameter associated with the widget increases or decreases in response to the motion of the dial. The position of dial 23 is measured relative to reference position 24.

Refer now to FIG. 1B, which illustrates a slider widget 25. The slider widget implements a virtual slider 26 that moves along a track 27 in response to the user touching virtual slider 26 and moving the user's finger in a direction along track 27. The distance between virtual slider 26 and reference position 28 sets the value of the parameter controlled by the slider widget.

As noted above, the accuracy with which a user can set the control parameter by using a finger to move the movable object on the widget is limited by the accuracy with which the touch screen sensor can determine the position of the user's finger on the screen. The accuracy can be increased by increasing the size of the widget relative to the size of the user's finger; however, there is a practical limit to this strategy that is determined by the size of the touch screen and the number of widgets that must be implemented in any particular application.

In addition, prior art widgets do not provide tactile feedback to the user. The user does not feel a physical object that the user is moving; hence, the user must watch the widget while the user is changing the value. If the value in question determines some parameter of a display that the user wishes to change, this poses a challenge, since the user typically wants to view the display while setting the control parameter.

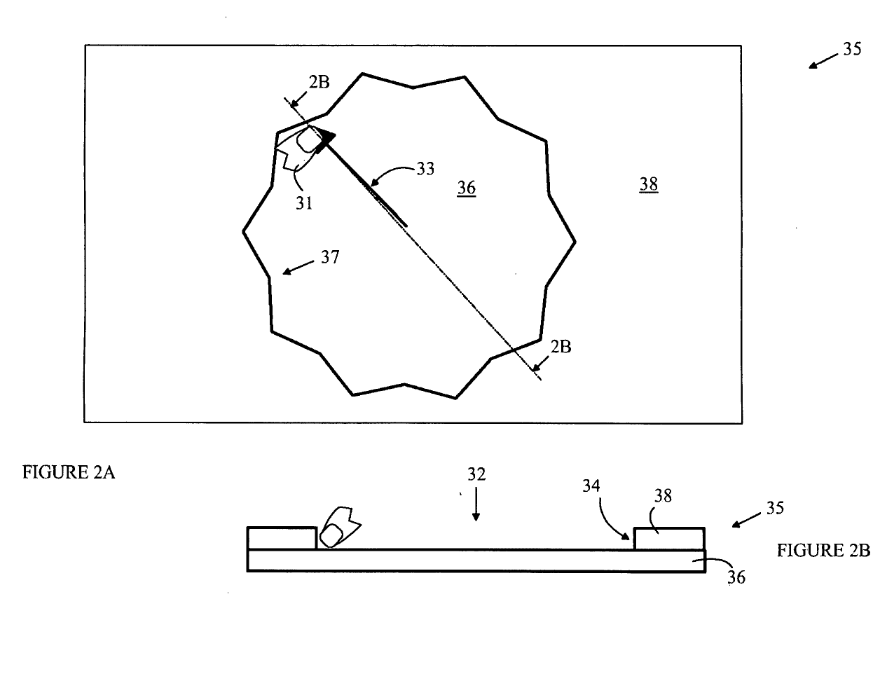

In one aspect of the present invention, tactile feedback is provided by incorporating an overlay on the touch screen that is aligned with the touch screen display and provides the tactile feedback. An overlay that allows the user to feel the movement of the user's finger with respect to the touch screen will be referred to as a tactile overlay in the following discussion. Refer now to FIGS. 2A-2B, which illustrate one embodiment of a tactile feedback overlay according to the present invention. FIG. 2A is a top view of widget 35 that is implemented with respect to a touch screen 36. FIG. 2B is a cross-sectional view of widget 35 through line 2B-2B shown in FIG. 2A.

The tactile overlay layer 38 includes an opening 32 in a layer of material that overlies the touch screen. Typically, layer 38 is mounted over touch screen 36. A dial widget 33 is displayed in opening 32. The edges 34 of opening 32 include protrusions 37 that the user senses as the user moves his or her finger on the surface of touch screen 36. Hence, the user receives tactile feedback that allows the user to sense the distance through which the dial is being moved without actually looking at the dial.

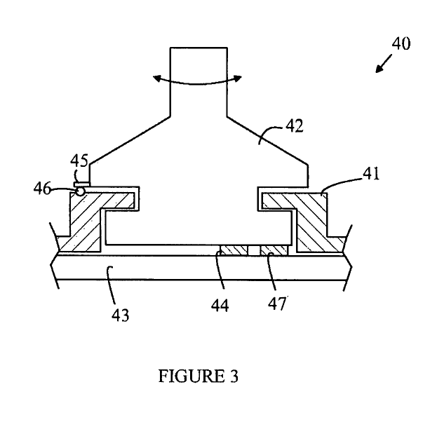

Refer now to FIG. 3, which illustrates another embodiment of a tactile feedback overlay that also includes an object that provides a more defined contact area with the touch screen. Widget 40 is also a dial widget. Widget 40 includes an overlay 41 having a physical knob 42 mounted therein. Overlay 41 constrains the motion of knob 42 such that knob 42 moves in a predetermined manner such as rotating about a predetermined center of rotation while remaining over the desired location on the touch screen. The bottom surface of knob 42 includes an object 44 that contacts screen 43 when the user presses the dial against the screen 43. In this embodiment, the touch screen uses an optical sensor to sense the position of object 44 when object 44 is pressed against screen 43. Accordingly, object 44 includes an optical pattern that aids in determining the position of object 44. However, embodiments in which object 44 is a stylus or other object that interacts electrically with screen 43 could also be constructed. The user then turns knob 42 to adjust the control parameter associated with widget 40. Since the user is turning a physical knob, the user can determine the degree of movement applied to the widget. If additional tactile feedback is required, the knob 42 could include a “clicker” in which a flexible member 45 moves over an indented surface 46 to allow the user to feel the degree of motion.

It should also be noted that the object that makes contact with the screen could include a number of sub-objects or some other distinct shape that enables the rotation of the knob to be more accurately determined. For example, if object 44 includes a plurality of discrete separated objects such as object 47, the touch screen can report back the position of each object, and hence, the rotation of the dial can be more accurately determined by fitting the detected locations to the known pattern with various rotations. In addition, the objects could be compressible so that the size of the object provides a measure of the pressure with which the object is pressed against the screen. The measured pressure can then be utilized to provide an additional parameter that can be measured and utilized to control a parameter in the system connected to the control panel. In such applications, the control determines the pressure applied by the user as well as the position at which the user touches the screen.

As noted above, one problem with prior art widgets is the accuracy with which the control parameter can be set. In another aspect of the present invention, a widget according to the present invention implements two gestures. The first gesture will be referred to as a value setting gesture and the second gesture will be referred to as a control gesture. A widget according to the present invention determines the value of some parameter in a device attached to the control panel that includes the widget. The functional relationship between the value, P, and the position, x, of the moveable element in the widget relative to a reference position in the widget will be denoted by P=f(x, G). In these embodiments, the value of x is altered by the value-setting gesture, and the value of G is altered by the control gesture.

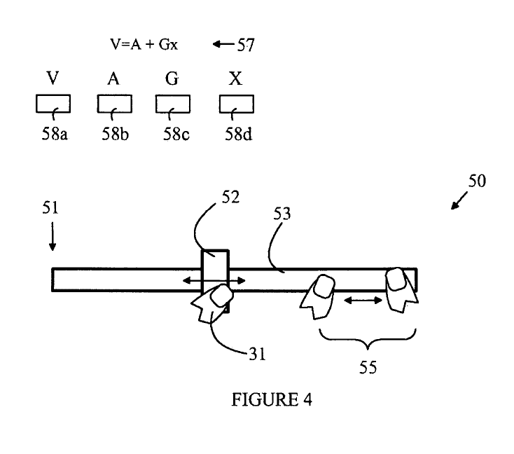

Refer now to FIG. 4, which illustrates a slider widget 50 according to another embodiment of the present invention. Slider widget 50 sets the value of a voltage, V, in an apparatus associated with the control panel in which the slider widget is implemented. The value of V depends on the distance, x, between the reference position 51 and the current location of element 52 in track 53. For example, the relationship between V and x could be given by

V=Gx

The value of x is set by touching element 52 with one finger and moving the finger in the appropriate direction as discussed above. The value of G is altered by placing two fingers in contact with the screen over slider widget 50 to provide two contact points and moving the fingers relative to each other to provide two contact points that move together or apart to decrease or increase the value of G as shown at 55.

In more complex relationships a number of different control gestures could be used to set the relationship. For example, consider the case in which the relationship between V and x is given by

V=A+Gx

The values of the offset, A, and the rate of change of V with x, G, are set by control gestures. In this case, it is useful to display the relationship between V, A, G, and X as shown at 57 in FIG. 4. The current values of the parameters are shown at 58a-58d, respectively.

To provide a “coarse-fine” adjustment of V, the value of A is initially set to 0. The user sets an approximation to V by sliding the moveable element to roughly the correct position. The user sets the value of A by touching the letter A on the widget, the value being set to the current value of A. The value of G is then set by touching C and executing a second control gesture such as that discussed above for setting G. The position of the widget is then reset to x=0 to allow the user to continue setting V from the previous value, but using the new gain to provide a finer control of the value of V.

In many situations, a control panel requiring a relatively large number of widgets is required to include an instrument or some other apparatus. As noted above, there is a tradeoff between the widget size on the display screen and the accuracy with which the corresponding parameter set by the widget can be adjusted. Hence, as the number of required widgets increases, the available accuracy for any given widget is reduced.

In one aspect of the present invention, one large widget is used to set a number of different parameters by moving the widget to different positions on the display screen. In essence, the parameter that is set by the widget is determined by a control gesture in which the widget is dragged to a predetermined location on the screen. As will be described in more detail below the dragging of the widget may be a virtual dragging or the movement of a physical embodiment of the widget such as the dial widget discussed above with reference to FIG. 3. After the parameter in question is set, the widget can then be moved to another location and the process repeated. During the setting of the control parameter by the widget, the widget can overlie other widgets or locations, and hence, a single large widget can be utilized without interfering with other widgets that set other control parameters in the device being controlled.

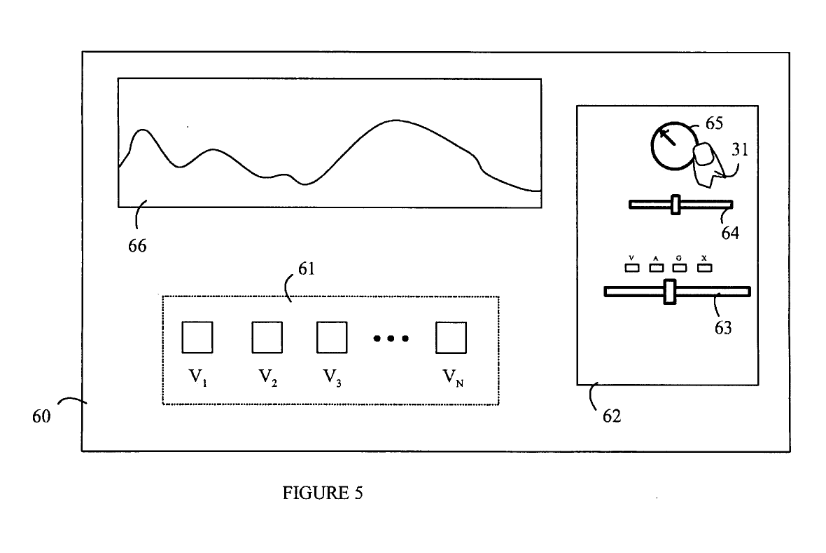

Refer now to FIG. 5, which illustrates a control panel according to another embodiment of the present invention. Control panel 60 is divided into three regions. The first region 61 contains a plurality of locations that correspond to various voltages, V₁ . . . V_{N}, that can be adjusted by utilizing one of the widgets contained in toolbox 62. Three exemplary widgets are shown at 63-65. Control panel 60 also includes a display 66 in which the value of a parameter related to the system being controlled is shown as a function of time. To adjust one of the voltages shown in region 61, the user drags the desired widget from toolbox 62 to the location corresponding to that voltage by touching the widget with the user's finger 31 and moving the finger across the surface of the touch screen.

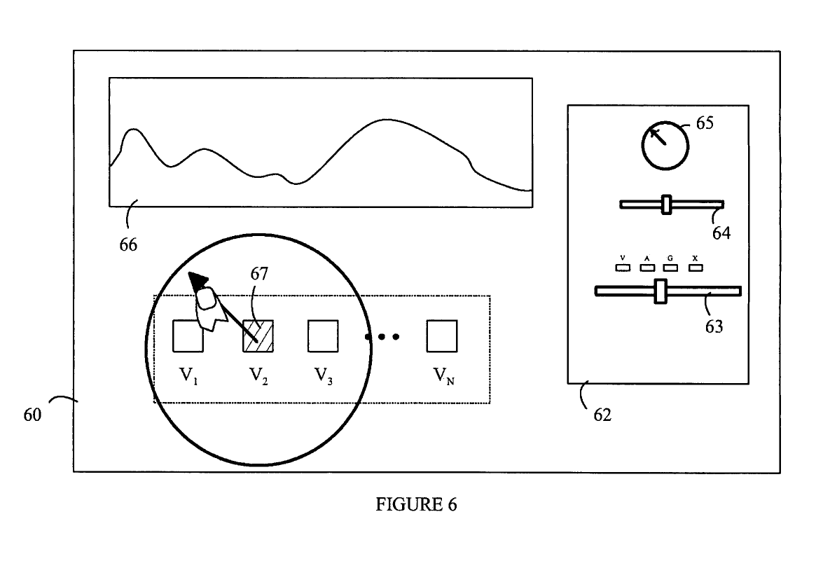

Refer now to FIG. 6, which illustrates the control panel shown in FIG. 5 after the user has moved the widget shown at 65 to the location that corresponds to adjusting the voltage V₂. When the weather widget is centered over the region corresponding to the voltage to be adjusted, the indicator for that voltage changes to reflect the selection of the voltage in question as shown at 67. The size of the widget also expands so that the user has finer control of the adjustment of the voltage. In this embodiment, the widget overlaps a number of locations at which the widget would appear if the widget were positioned at one of the other locations. When the user is finished making the adjustment, the user drags the widget back to toolbox 62.

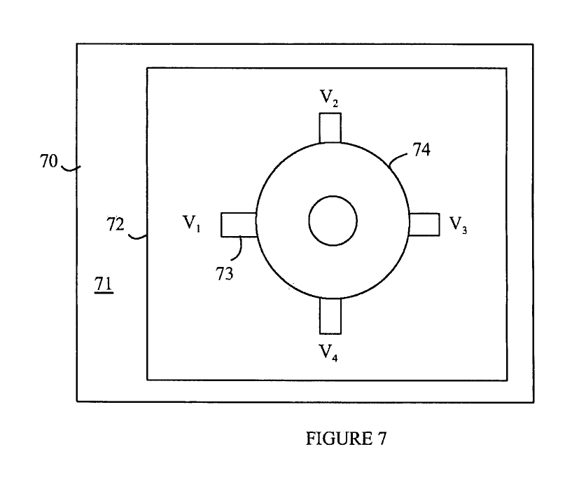

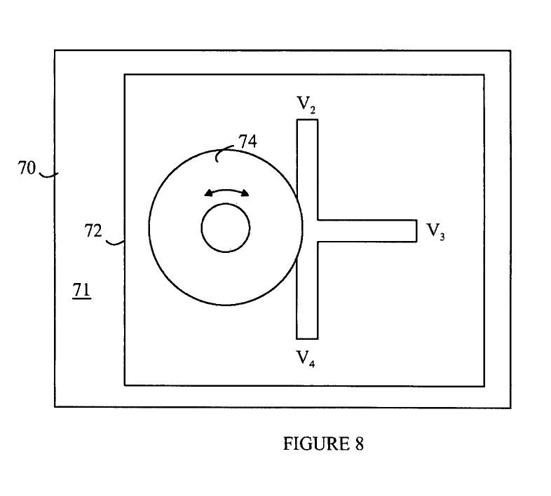

The use of the position of the widget to determine which parameter on the control panel is to be adjusted may also be practiced with widgets that include a physical knob or other object that is grasped by the user. Referring now to FIGS. 7 and 8, which illustrate the use of a widget that includes a knob such as that discussed above with reference to FIG. 3 that moves in a track between various positions corresponding to different parameters that can be adjusted. The track restrains the allowable locations of knob 74 while preventing knob 74 from becoming separated from control panel 70. Control panel 70 is implemented over a touch screen 71. An overlay 72 includes a slotted structure 73 in which a knob 74 moves. Knob 74 includes a structure on the bottom surface thereof that can be tracked by touch screen 71. By moving knob 74 in slotted structure 73 to one of the extreme positions, knob 74 can then be used to adjust the parameter that corresponds to the position in question. For example, when knob 74 is moved to the position labeled by V₁, as shown in FIG. 8, the parameter V₁ is adjusted by turning knob 74.

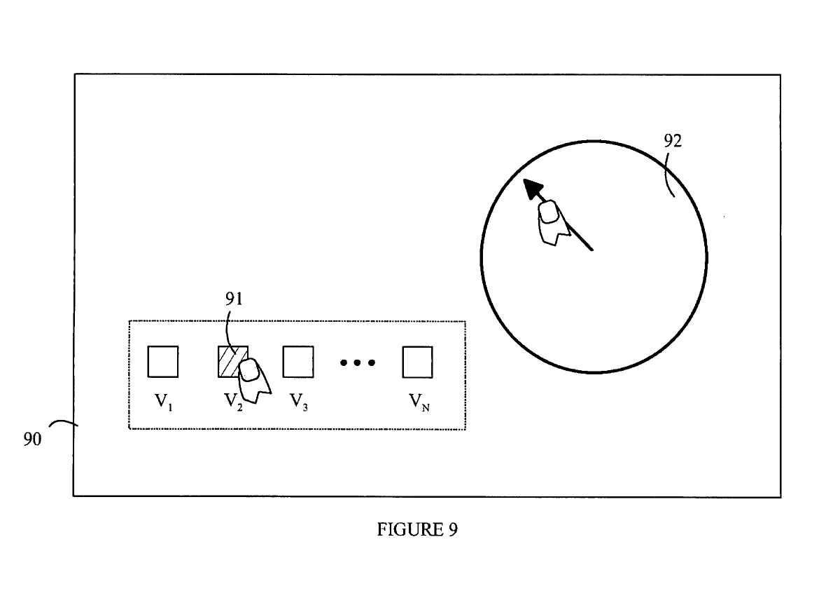

In the embodiment shown in FIGS. 5 and 6, the user selected the widget from the toolbox and moved the widget to the location of the parameter that is to be adjusted. However, embodiments in which a widget is associated with each location can also be constructed. Refer now to FIG. 9, which illustrates another embodiment of a control panel according to the present invention. Control panel 90 includes a number of predefined locations corresponding to different parameters that can be adjusted using a widget. Each location has a widget associated therewith. When the widget is not being used to adjust the parameter associated with that location, the widget is hidden. When the user selects a particular parameter for adjustment by touching the corresponding location as shown at 91, the widget associated with that parameter appears on the screen as shown at 92. After the user adjusts the parameter in question, the user executes another gesture that causes the widget to be hidden. For example the user could touch a location on the touch screen that is outside of widget 92.

In the above-described embodiments, a single widget is used to set the value of a parameter in a device controlled by the control panel in which the widget is located. In some applications, setting the parameter using a plurality of widgets, or a widget and some other means for setting the parameter, can be useful. For the purposes of the present discussion, a widget will be defined to be bi-directionally coupled to a parameter that the widget can alter if the value displayed on the widget is altered when the parameter is altered using a mechanism other than that widget.

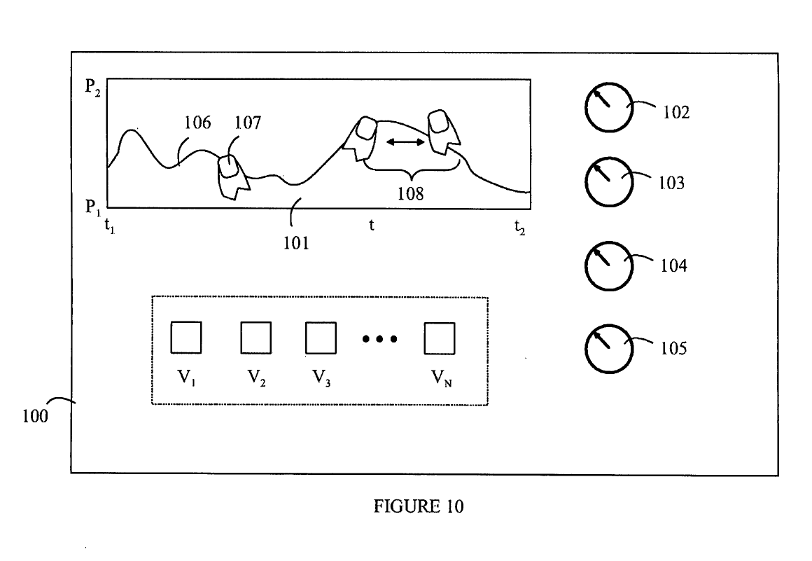

Referring now to FIG. 10, which illustates another embodiment of the control panel according to the present invention. Control panel 100 includes a display 101 and a plurality of bi-directionally coupled widgets shown at 102-105, which alter the parameters of display 101. In this example, display 101 shows a curve 106 which represents the value of a parameter in the device that is being controlled as a function of time. In this example, widgets 102-105 set the parameter values t₁, t₂, P₁, and P₂, respectfully. The values of these parameters are indicated by the dial positions in widgets 102 that can be set by moving the dials in the manner discussed above. In some applications, setting these parameters by using a third gesture such as dragging curve 106 using a finger movement such as shown at 107 may be a more convenient means for setting some of the parameters. In addition, the scales may be altered by using two-finger gestures such as those shown at 108. The values shown in the widgets are coupled to the actual values that the widgets control so that when the parameters are altered by the gestures in display 101, the value indications shown in the dials are altered to display the new results.

The above-described embodiments utilize the position of the touch event to alter the parameter being controlled or provide other input to the control panel. However, it should be noted that signals from touch events can contain more information than just the position on the screen at which the touch occurred. Depending on the touch screen technology, the size of the area touched, the shape of the contact area, the pressure on the screen, etc. can be provided. The information provided by the gesture on the touch screen can provide these additional parameters and those parameters can also be used in setting the parameter or parameters controlled by the widget.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. A control panel comprising:
a touch screen and
a widget implemented on said touch screen, said widget controlling a parameter in a device that is controlled by said control panel, said widget responding to a first gesture that sets a value for said parameter and a second gesture that alters a function that determines a relationship between said first gesture and said value.

2. The control panel of claim 1 wherein said first gesture comprises moving an object across said touch screen.

3. The control panel of claim 1 wherein said second gesture comprises moving two contact points across said touch screen, a distance between said contact points changing during said movement.

4. The control panel of claim 1 wherein said touch screen determines a pressure applied to said touch screen, said pressure altering a response of said widget to said first or second gesture.

5. The control panel of claim 1 further comprising an overlay on said touch screen aligned with said widget such that a user receives tactile feedback when said user executes said first gesture.

6. The control panel of claim 1 wherein said widget includes a layer that overlies said touch screen and restrains an object to move in a predetermined manner determined by said first gesture.

7. The control panel of claim 2 wherein said object comprises an element that is detected by said touch screen.

8. The control panel of claim 5 wherein said object comprises an element that rotates in said overlay.

9. The control panel of claim 1 wherein said second gesture determines which of a plurality of parameters in said device is altered by said widget.

10. The control panel of claim 9 wherein said second gesture comprises moving said widget to a predetermined location on said touch screen, said predetermined location determining which of said parameters is altered by said first gesture.

11. The control panel of claim 9 wherein said touch screen comprises a track that constrains an object that is part of said widget to particular locations on said touch screen, said parameter that is altered being determined by a position of said object in said track.

12. The control panel of claim 1 further comprising a toolbox displayed on said touch screen, said toolbox containing a plurality of widgets that can be moved to specified locations on said touch screen.

13. The control panel of claim 1 wherein said widget is moveable on said touch screen and wherein said widget changes size when positioned at predetermined locations on said touch screen.

14. The control panel of claim 13 wherein each predetermined location corresponds to a different parameter that is to be altered by said widget.

15. The control panel of claim 1 wherein said parameter can also be set by an action other than said first gesture of said widget and wherein said widget includes an indication of a parameter value that is altered when said parameter is set by said other action.

16. The control panel of claim 15 further comprising a display implemented on said touch screen, said control panel responding to a third gesture corresponding to said display by altering said parameter, said third gesture determining said indication.

17. The control panel of claim 1 wherein said touch screen includes a plurality locations, each location corresponding to a different parameter in said device and wherein each location is associated with a widget that appears when that location is selected by a user.

18. The control panel of claim 17 wherein said widget has a size that overlaps a plurality of said locations.

19. The control panel of claim 1 wherein said second gesture alters a rate of change of said parameter in response to said first gesture.

20. The control panel of claim 1 wherein said second gesture determines an offset that is applied to said parameter.
